(19) United States
(12) Patent Application Publication
(10) Pub. No.: US 2009/0145773 A1
(43) Pub. Date: Jun. 11, 2009

(54) Membrane Cycle Cleaning

(75) Inventor: Rodney E. Herrington, Albuquerque, NM (US)

Correspondence Address: PEACOCK MYERS, P.C., 201 THIRD STREET, N.W., SUITE 1340, ALBUQUERQUE, NM, 87102, US

(73) Assignee: MIOX Corporation, Albuquerque, NM (US)

(21) Appl. No.: 12/329,416

(22) Filed: Dec. 5, 2008

Related U.S. Application Data
(60) Provisional application No. 60/992,969, filed on Dec. 6, 2007.

(51) Int. Cl. C25F 1/00; G01N 27/26

(52) U.S. Cl. 205/687; 204/400; 204/276; 204/275.1

(57) ABSTRACT

Method and apparatus for cleaning a membrane system by using electrolysis to replenish the quantity and quality of the disinfectant solution. An electrolytic cell is preferably mounted in a recirculation piping line in connection with the chlorine-containing vat that is used to clean membranes. The electrolytic cell converts chloride produced in the membrane cleaning process to chlorine or other oxidants, thereby replenishing the cleaning solution and enabling it to be recycled.

### CROSS-REFERENCE TO RELATED APPLICATIONS

This application claims priority to and the benefit of filing of U.S. Provisional Patent Application Ser. No. 60/992,969, entitled “Membrane Cycle Cleaning”, filed on Dec. 6, 2007, which is incorporated herein by reference.

### BACKGROUND OF THE INVENTION

1. Field of the Invention (Technical Field)

The present invention relates to a filtration membrane cleaning process whereby an electrolytic process is utilized to maintain the concentration and efficacy of a chlorine based cleaning solution.

2. Background Art

Note that the following discussion refers to a number of publications and references. Discussion of such publications herein is given for more complete background of the scientific principles and is not to be construed as an admission that such publications are prior art for patentability determination purposes.

Commercial electrolytic cells that utilize a flow-through configuration have been used routinely for oxidant production; the cell may or may not be under pressure sufficient to create flow through the electrolytic device. Examples of cells of this configuration are described in U.S. Pat. No. 6,309,523 to Prasnikar et al., entitled “Electrode and Electrolytic Cell Containing Same,” and U.S. Pat. No. 5,385,711 to Baker et al., entitled “Electrolytic Cell for Generating Sterilization Solutions Having Increased Ozone Content”.

Many swimming pools today utilize flow through chlorinators to maintain the chlorine concentration in the pool. This method utilizes an elevated sodium chloride salt concentration in the swimming pool. As the water in the pool is circulated through the filter and pumping system, the water passes through an electrolytic cell. If the chlorine level in the pool is too low, measured manually or automatically, the chlorinator is activated, thereby converting the chloride in the salt water to chlorine. This maintains the proper chlorine level in the swimming pool for effective disinfection.

Because filtration membranes of various types, including microfiltration, ultrafiltration, nanofiltration, and reverse osmosis membranes, are becoming more popular for potable water and wastewater filtration, the need exists to clean the membranes. The primary membrane types are hollow fiber and spiral wound elements. Membranes become fouled for various reasons, including silt loading, scale forming on the membrane, organic loading, and biofilm buildup. Conventional filtration membrane cleaning processes include acid washing to remove scale, followed by chlorine and caustic cleaning, such as that using sodium hypochlorite bleach at high concentrations, to remove organics and biofilms. Various other methods have also been employed, including air sparging, which may be used in conjunction with solution cleaning. As the membrane is placed in the cleaning solution, the chlorine in the solution is converted to chloride. Ultimately, after several cleanings—depending on the degree of contamination—the chlorine solution is no longer effective and must be discarded. Discarding the chlorine cleaning solution is not desirable as it is usually considered hazardous waste.

### SUMMARY OF THE INVENTION (DISCLOSURE OF THE INVENTION)

The present invention is a method for cleaning a membrane, the method comprising the steps of disposing a cleaning solution comprising at least one oxidant in a container, cleaning the at least one membrane with the cleaning solution, thereby reducing the oxidant concentration of the cleaning solution; moving depleted cleaning solution from the container to an electrolytic cell; increasing the oxidant concentration of the cleaning solution by electrolyzing the cleaning solution; and returning replenished cleaning solution to the container. The method optionally further comprises the steps of detecting the oxidant concentration of the cleaning solution and initiating the moving step when the oxidant concentration drops below a predetermined level. The detecting step optionally comprises monitoring the free available chlorine level in the cleaning solution. The container optionally comprises a filtration membrane housing for containing the at least one membrane while the at least one membrane filters a fluid. In this case the method is preferably performed without removing the at least one membrane from the filtration membrane housing, and the cleaning solution is preferably stored while the at least one membrane filters a fluid. The cleaning step optionally comprises backwashing the at least one membrane. The method preferably further comprises one or more operations selected from the group consisting of air sparging the cleaning solution, filtering particulates from the cleaning solution, and pumping the cleaning solution to and/or from the container.

The present invention is also an apparatus for cleaning a membrane, the apparatus comprising a container comprising a cleaning solution comprising at least one oxidant for cleaning the membrane; and an electrolytic cell for increasing the oxidant concentration of the cleaning solution; and a pump for moving cleaning solution between the container and the electrolytic cell. The apparatus preferably further comprises an oxidant monitor for detecting the oxidant concentration, preferably monitoring the free available chlorine monitor level in the cleaning solution. The apparatus preferably further comprises a particulate filter. The container optionally comprises a housing for containing the membrane while the membrane filters a fluid and a tank for storing cleaning solution while the membrane filters a fluid.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a schematic view of an embodiment of the membrane cleaning apparatus of the present invention; and

FIG. 2 is a schematic view of an in-situ membrane cleaning configuration of the present invention.

### DESCRIPTION OF THE PREFERRED EMBODIMENTS (BEST MODES FOR CARRYING OUT THE INVENTION)

As used throughout the specification and claims, the term “membrane” means any filtration element or membrane, including but not limited to microfiltration, ultrafiltration, nanofiltration, or reverse osmosis membranes, or hollow fiber and spiral wound elements.

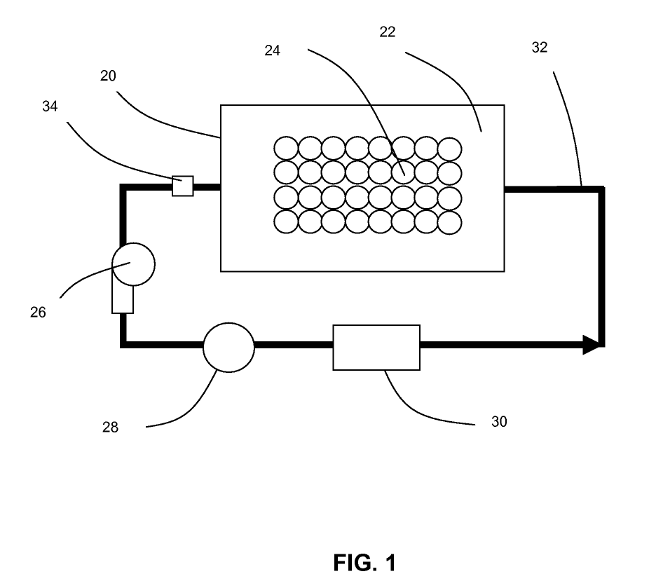

The present invention comprises an electrolytic cell that is preferably mounted in the piping recycle line in a filtration membrane cleaning vat. Referring to FIG. 1, cleaning vat 20 contains cleaning solution 22, which typically comprises chlorine or one or more other oxidants, such as a chlorine based mixed oxidant solution. Optionally, cleaning vat 20 may initially contain only water or an aqueous solution, to which sodium chloride or brine is added, in which case electrolytic cell 30 is preferably used to generate the chlorine or oxidants. Membrane array 24 is preferably removed from its service housing and disposed in membrane cleaning vat 20 to soak the filtration membranes in cleaning solution 22 for an adequate time to clean contaminants from the membrane surface. Although an array of filtration membranes is shown, the present invention will work with a single membrane or any number of membranes, whether or not arrayed. Membrane array 24 may optionally also undergo an air sparging operation to facilitate the cleaning process.

As membrane array 24 is cleaned of contaminants, cleaning solution 22 is depleted of active chlorine or other oxidants, which during the cleaning process are typically converted back to chloride ions and other constituents in the solution. In order to replenish the chlorine or oxidant concentration and quality of cleaning solution 22, cleaning solution 22 is pumped by recirculation pump 26 through recirculation piping 32, and preferably particulate filter 28, through electrolytic cell 30. Electrolytic cell 30 preferably comprises dimensionally stable anodes. Electrolytic cell 30 preferably applies electrical energy to the aqueous halide salt solution in cleaning solution 22 between an anode plate and cathode plate to convert the salt solution to oxidants that can be used for disinfection. Within electrolytic cell 30, electrical power is applied to the solution, thereby converting the chloride in cleaning solution 22 back to chlorine or other oxidants. The replenished cleaning solution is then pumped back to cleaning vat 20. Thus cleaning solution 22 in cleaning vat 20 is preferably recycled, thereby replenishing and maintaining the appropriate chlorine or oxidant concentration in the bulk cleaning solution. In this manner, cleaning solution 22 is not depleted, and need not be discarded.

In order to maintain the correct chlorine or oxidant concentration within cleaning solution 22, chlorine monitor 34 is preferably incorporated into recirculation piping 32, or alternatively at least partially within cleaning vat 20. When the free available chlorine (FAC) in cleaning solution 22 drops below a certain predetermined level, an electrical signal from chlorine monitor 34 preferably provides the control signal to activate electrolytic cell 30 to convert more of the chloride in cleaning solution 22 back to chlorine or other oxidants, thereby maintaining the appropriate concentration and quality of cleaning solution 22. Typical FAC levels range from approximately 100 ppm to 2000 ppm, and is most preferably approximately 500 ppm. Cleaning solution 22 may be continuously recycled by recirculation pump 26, or may operate in batch mode, for example after electrolytic cell 30 is activated as described above.

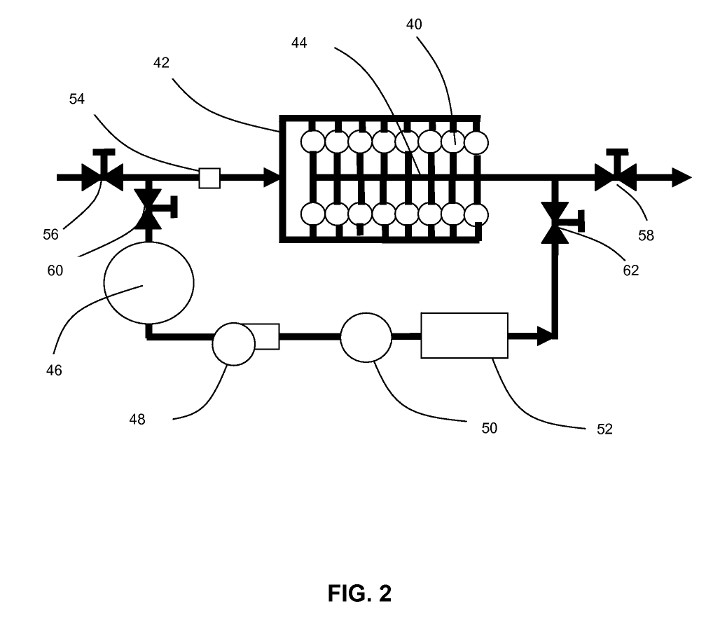

In an alternative embodiment of the present invention, the cleaning and recycling operation is conducted with the membrane elements in-situ—still in their normal containment housings. Referring to FIG. 2, contaminated water or other fluid normally flows from left to right through inlet valve 56 which is open, and then enters inlet manifold 42 and membrane filters 40. Filtered water then passes into outlet manifold 44 and through outlet valve 58 where the finished water is utilized, or subject subsequent processing such as disinfection, as desired. In the normal filtering water mode, recycle isolation valves 60 and 62 are closed. In the filter backwash mode, water inlet valve 56 and water outlet valve 58 are closed, and recycle inlet valve 60 and recycle outlet valve 62 are open. Pump 48 draws cleaning solution preferably from storage tank 46, through contaminant filter 50, electrolytic cell 52, and recycle outlet valve 62, and into water outlet manifold 44. The solution is flushed in reverse through water filters 40, which are cleaned in the process, and out through water inlet manifold 42, through recycle inlet isolation valve 60, and into storage tank 46. In order to maintain the correct chlorine or oxidant concentration within the cleaning solution, chlorine monitor 54 is preferably incorporated within the water inlet piping or storage tank 46. An electrical signal from chlorine monitor 54 preferably provides the control signal to activate electrolytic cell 52 to convert more of the chloride in the previously used cleaning solution back to chlorine, thereby maintaining the appropriate concentration and quality of the cleaning solution.

Thus, in addition to providing a means for controlling the level of chlorine concentration in a membrane cleaning solution, it provides a disinfectant solution that is more effective than conventional sodium hypochlorite and gas chlorine. Mixed oxidant chemistry generated from a brine solution at elevated energy levels has been shown to be more effective as a disinfectant than conventional chlorine, whether sodium hypochlorite, calcium hypochlorite, or gas chlorine. As a result, the better and more complete cleaning of the membrane reduces waste disposal and improves the operational duty cycle of the membrane.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method for cleaning a membrane, the method comprising the steps of:
disposing a cleaning solution comprising at least one oxidant in a container;
cleaning the at least one membrane with the cleaning solution, thereby reducing an oxidant concentration of the cleaning solution;
moving depleted cleaning solution from the container to an electrolytic cell;
increasing the oxidant concentration of the cleaning solution by electrolyzing the cleaning solution; and
returning replenished cleaning solution to the container.

2. The method of claim 2 further comprising the steps of:
detecting the oxidant concentration in the cleaning solution; and
initiating the moving step when the oxidant concentration drops below a predetermined level.

3. The method of claim 3 wherein the detecting step comprises monitoring a free available chlorine level in the cleaning solution.

4. The method of claim 1 wherein the container comprises a filtration membrane housing for containing the at least one membrane while the at least one membrane filters a fluid.

5. The method of claim 4 performed without removing the at least one membrane from the filtration membrane housing.

6. The method of claim 4 further comprising the step of storing the cleaning solution while the at least one membrane filters a fluid.

7. The method of claim 4 wherein the cleaning step comprises backwashing the at least one membrane.

8. The method of claim 1 further comprising one or more operations selected from the group consisting of air sparging the cleaning solution, filtering particulates from the cleaning solution, and pumping the cleaning solution to and/or from the container.

9. An apparatus for cleaning a membrane, the apparatus comprising:
a container comprising a cleaning solution comprising at least one oxidant for cleaning the membrane; and
an electrolytic cell for increasing an oxidant concentration of said cleaning solution; and
a pump for moving cleaning solution between said container and said electrolytic cell.

10. The apparatus of claim 9 further comprising an oxidant monitor for detecting said oxidant concentration.

11. The apparatus of claim 10 wherein said oxidant monitor monitors a free available chlorine monitor level in the cleaning solution.

12. The apparatus of claim 9 further comprising a particulate filter.

13. The apparatus of claim 9 wherein said container comprises a housing for containing said membrane while said membrane filters a fluid.

14. The apparatus of claim 13 further comprising a tank for storing cleaning solution while said membrane filters a fluid.
